(19) United States
(12) Patent Application Publication
(10) Pub. No.: US 2007/0047020 A1
(43) Pub. Date: Mar. 1, 2007

(54) System and method for printing plural documents on one page

(75) Inventor: Young-gu Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/499,715

(22) Filed: Aug. 7, 2006

(30) Foreign Application Priority Data
Aug. 25, 2005 (KR) 2005-78224

(51) Int. Cl. H04N 1/387

(52) U.S. Cl. 358/450

(57) ABSTRACT

A printing system for printing corresponding pages of plural documents on one page or a series of one pages for easy comparison, which includes: a user interface in which a plural print option for printing each corresponding page of plural documents on one page or series of one pages is set; a converting unit for converting the plural documents selected by a user into print data to be printed on one page or series of one pages; and a printing unit for printing the print data. As a page or portion thereof from each of at least two documents can be printed on one page, a user can conveniently compare the documents.

### CROSS-REFERENCE TO RELATED APPLICATIONS

This application claims benefit under 35 U.S.C. §119 of Korean Patent Application No. 2005-78224, filed on Aug. 25, 2005, in the Korean Intellectual Property Office, the entire content of which is incorporated herein by reference.

### BACKGROUND OF THE INVENTION

1. of the Invention

Aspects of the present invention relates in general to a system and method for printing plural documents on one page, and more specifically, to a system and method for printing at least two different documents on one print page, whereby a user (viewer) can easily compare the documents to each other.

2. Description of the Related Art

N-up printing is a method for printing multiple publication pages of a document on a single sheet of print page (N is the number of columns printed across the page). For example, 4-up printing accommodates four pages of a document side-by-side on one page.

However, a drawback of the traditional N-up printing is that a user can print pages from only one document. Therefore, to compare at least two different documents to each other, each document had to be printed separately.

### SUMMARY OF THE INVENTION

Accordingly, aspects of the present invention provide a system and method of printing plural documents on one page to enable a user to print corresponding portions or pages of at least two different documents on one page or sheet so that the user can conveniently compare the different documents to each other at one time.

Additional aspects and/or advantages of the invention will be set forth in part in the description which follows and, in part, will be obvious from the description, or may be learned by practice of the invention.

Accordingly, aspects of the present invention provide a printing system to print plural documents on one page, including: a user interface in which a plural print option for printing plural documents on one page is set; a converting unit to convert the plural documents into print data to be printed as portions or pages of the plural documents on one page; and a printing unit to print the print data.

According to an aspect of the invention, the printing system further includes: a storage unit to store the plural documents for which the plural print option is set, and in an embodiment, the converting unit converts the plural documents stored in the storage unit into print data to be printed as corresponding portions or pages of the plural documents on one page.

According to an aspect of the invention, the printing system further includes: a preview screen processing unit to generate a preview screen of the print data and display the preview screen on the user interface.

Another aspect of the present invention provides a printing method of printing plural documents on one page, including: obtaining a plural print option for printing plural documents on one page; converting the plural documents into print data to be printed on one page; and printing the print data.

According to an aspect of the invention, the printing method further includes: storing the plural documents for which the plural print option is set, and in the conversion operation the plural documents stored in the storage unit are converted into print data to be printed on one page.

According to an embodiment, at least one of: the number of the plural documents to be printed on one page, the document sequence, the page split method, the document size, and the preview option is obtained as the plural print option.

According to an embodiment, the conversion is executed when the number of plural documents set in the plural print option corresponds to a predetermined document number.

According to an embodiment, even though the number of plural documents set in the plural print option does not correspond to the predetermined document number, the conversion is executed in case a prompt plural print option is set.

According to an embodiment, the conversion is executed according to a predetermined print sequence, and the print sequence is changeable.

According to an embodiment, the conversion is executed according to either a horizontal page split method or a vertical page split method.

According to an embodiment, the conversion is executed according to a predetermined document size.

According to an aspect of the present invention, the printing method further includes: displaying a preview screen of the print data.

According to an aspect of the invention, the conversion is realized in a printer driver.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a functional block diagram illustrating the configuration of a printing system, according to one embodiment of the present invention;

FIG. 2 illustrates a user interface for setting print options, according to one embodiment of the present invention;

FIGS. 3A through 3G illustrate various display forms of plural documents printed on one page, according to one embodiment of the present invention;

FIG. 4 is a flow chart explaining a printing method according to one embodiment of the present invention; and

FIG. 5 illustrates a user interface used for setting print options, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

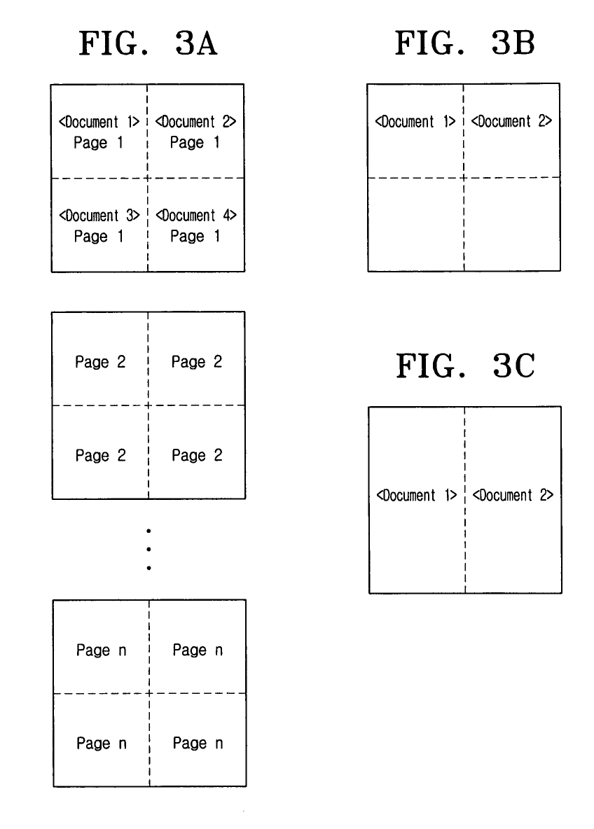

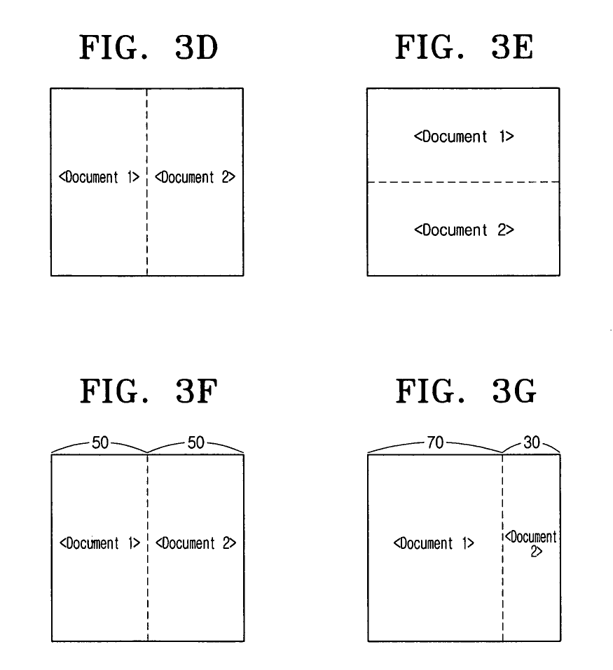

FIGS. 3A through 3G illustrate various display forms of plural documents printed on one page, according to one embodiment of the present invention. For example, FIG. 3A shows corresponding pages from each of four different types of documents printed on one page. As shown in the drawing, pages having the same page numbers from each of the documents are printed on one page consecutively, and therefore a user can conveniently compare those four documents simultaneously side-by-side. If there is no corresponding page of a certain page number in any of the documents, that area of the printed one page may be printed blank. Depending on embodiments, various arrangements of pages from the documents on the one page can be achieved such as different numbers of documents can be designated, the documents can be laid out in a different order, a various number of corresponding pages from each document can be laid out on the same printed one page, fractions of corresponding pages from each document can be printed on one page, the document pages can be arranged horizontally or vertically on the one page, and the pages from a document can be given a specific proportional size on the one page. While described as printing corresponding pages from each document, it is understood that portions of pages from each document can be printed on one page, where portions of pages include such parts as paragraphs, sentences, figures, and other blocks of text and/or graphics.

Further, according to an embodiment of the invention, it is understood that the printed one page can be a series of pages where a first printed page will have printed thereon such an arrangement as a first page of a first document, a first page of a second document, a first page of a third document, etc. A second printed page in the series will then have a similar arrangement of a second page of the first document, a second page of the second document, a second page of the third document, etc. A third printed page in the series will similarly have the third page from each of the documents printed thereon, as will a fourth printed page have the corresponding fourth page of each document, a fifth printed page will have the corresponding fifth page of each document, etc.

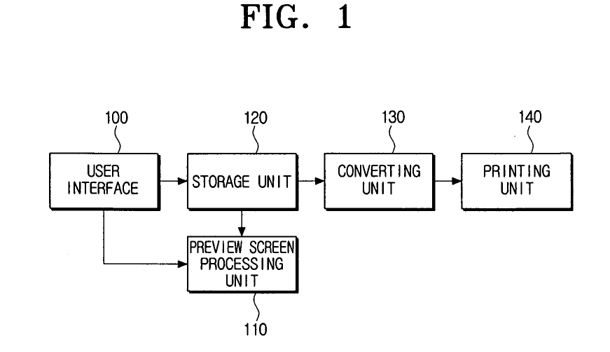

FIG. 1 is a functional block diagram showing the configuration of a printing system according to one embodiment of the present invention. As can be seen in FIG. 1, the print system includes a user interface 100, a storage unit 120, a converting unit 130, a printing unit 140, and/or a preview screen processing unit 110 if desired.

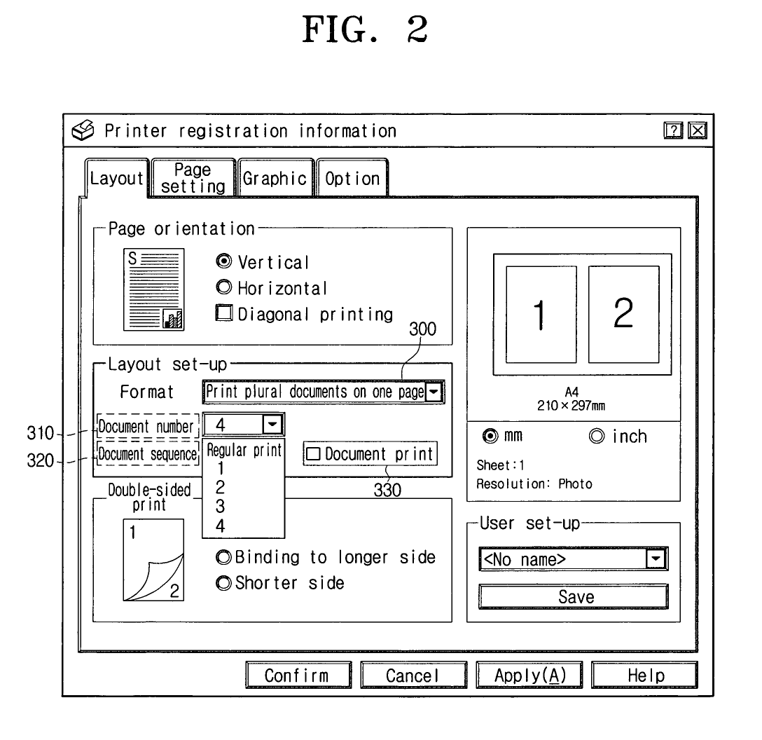

FIG. 2 illustrates a user interface for setting print options, according to one embodiment of the present invention. The user interface 100 is constituted with a print format set-up unit 300, a document number set-up unit 310, a document sequence set-up unit 320, and a prompt plural print option set-up unit 330.

A user opens a document to be printed using an application program, and executes a print function. To this end, the interface shown in FIG. 2 for example may be provided. The user sets a desired print format of the document of interest through the print format set-up unit 300. If the user selects an option, e.g., “Print plural documents on one page”, the printing system will print corresponding pages or portions of pages from a plurality of documents on one print page. Later, when the user opens another document and the interface of FIG. 2 is provided, he can change the print format in the print format set-up unit 300. In other words, after the user opens plural documents in the application programs and checks their contents, he may determine whether to print the plural documents on one page or print only a document of interest using a regular printing method. In this specification, the regular printing method is used to refer to printing pages from a single document on each one page, not pages from plural documents together on the one page.

For example, the user can set the first document he opened in the application program to be used for plural document printing, the second document for the regular printing, and the third document for plural document printing together with the first document. Even though the option, “Print plural documents on one page,” is set in the print format set-up unit 300, a single document of interest can still be printed alone when the user selects “Regular print” in the document sequence set-up unit 320.

The document number set-up unit 310 allows the user to set the number of documents he wants to print, that is, the quantity of different documents from which the printing system will print corresponding pages on the one page.

The document sequence set-up unit 320 allows the user to set the sequence of documents being printed on one print page. For example, after the user sets the number of documents to be printed in the document number set-up unit 310, the document sequence set-up unit 320 displays numerals, such as, 1, 2, 3, . . . , correspondingly to the document number set by the user. Moreover, the document sequence set-up unit 320 may designate the smallest number among the displayed numerals as a default value. Of course, the user can change the value of the document sequence from the default value at any time.

For example, suppose that the user set ‘4’ in the document number set-up unit 310. Then, the document sequence set-up unit 320 displays numerals from 1 to 4, and designates 1 (which is the smallest) as a default value. At this point, suppose the user changes the document sequence to ‘3’. If the user opens a second document, the document sequence set-up unit 320 may display numerals from 1 to 4 (in this example, ‘4’0 is set in the document number set-up unit 310), except for the previously set numeral 3 the previous document (the numeral 3 may appear faded and not be selectable or may not appear). The default document sequence value of this second document is 1, the smallest value available among the remaining document sequence values.

The prompt plural print option set-up unit 330 provides an interface to enable printing of documents that have been previously set even though the total number of documents set by the document number set-up unit 310 may not be selected by the user. For example, suppose that ‘4’ was originally set in the document number set-up unit 310. However, if the user sets only two documents and checks “Print document” from the prompt plural print option 330 in FIG. 2, only two documents are printed on one page. This is convenient to the user, and it also demonstrates that the user can change the document number 310, e.g., from ‘4’ to ‘2’, at any time.

Although the user interface 100 may not have the document number set-up unit 310 in an embodiment of the invention, when the user simply sets the plural documents he wants to print on one page and checks the “Print document” in the prompt plural print option set-up unit 330 in FIG. 2, the plural documents selected by the user are printed on one page.

The storage unit 120 stores one or more documents which the user has set to the plural print option. In other words, the storage unit 120 stores documents until all of the documents to be printed on one page are selected by the user. In FIG. 2, if the “Print plural documents on one page” is set in the print format set-up unit 300, the storage unit 120 stores the corresponding document. Although the “Print plural documents on one page” may have been set in the print format set-up unit 300, if the user sets the “Regular print” in the document sequence set-up unit 320, only the document of interest is printed as if the “Print plural documents on one page” had not been set in the print format set-up unit 300 while not disturbing the documents stored in the storage unit 120.

In addition, the storage unit 120 stores the number of documents set in the document number set-up unit 310, and the document sequence set in the document sequence set-up unit 320. In an embodiment of the invention, the storage unit 120 might miniaturize each page of the documents according to the document number set in the document number set-up unit 310, and store the pages in miniature. For instance, in a case where four documents are set in the document number set-up unit 310, the storage unit 120 might reduce each page of the documents to ¼ of the page size. If the storage unit 120 stores the pages of the documents without miniaturizing the pages, the converting unit 130 (to be described) miniaturizes the pages.

The converting unit 130 converts plural documents set to the plural print option into print data so that corresponding pages of the plural documents can be printed on one page. If the number of documents stored in the storage unit 120 is the same as the document number set in the document number set-up unit 310, the converting unit 130 converts the plural documents in the storage unit 120 into print data so that corresponding pages of each of the plural documents can be printed on one page. Also, the converting unit 130 combines and converts each page of the documents on one print page according to a predetermined printing sequence. Here, the printing sequence of the documents can be set in the document sequence set-up unit 320.

Moreover, when the prompt plural print option 330 is set, the converting unit 130 converts the plural documents into print data to be printed on one page, as in the case where the number of documents stored in the storage unit 120 is the same as the document number set in the document number set-up unit 310. This is to provide convenience to the user in printing plural documents on one page even when the number of documents stored in the storage unit 120 is not equal to the document number set in the document number set-up unit 310. As aforementioned, the document number set-up unit 310 need not be available in an embodiment of the invention, in such an instance the converting unit 130 can convert the plural documents that the user selected to print on one page once the prompt plural print option 330 is set.

The converting unit 130 miniaturizes each page of the documents stored in the storage unit 120 according to the document number set in the document number set-up unit 310. The converting unit then lays out a corresponding page from each document side-by-side across one print page (and a next corresponding page from each document on a next print page and a next, etc., until all corresponding pages are exhausted). If the storage unit 120 miniaturizes and stores each page of the document in advance, the converting unit 130 just lays out the miniaturized pages side-by-side. If there is no document number set-up unit 310, the converting unit 130 miniaturizes each page of the document according to the number of plural documents set when the prompt plural print option is set and lays out each corresponding page of those documents side-by-side.

When the prompt plural print option 330 is set, the converting unit 130 may miniaturize the pages of the documents and lay out the corresponding pages as shown in FIGS. 3B or 3C. For example, suppose that the number of documents set in the document number set-up unit 310 is “4”. If the user sets only two documents and checks the “Print document” in the print plural print option set-up unit 330 in FIG. 2, the converting unit 130 miniaturizes and lays out the pages of the documents as shown in FIG. 3B according to the document number set in the document number set-up unit 310, or as shown in FIG. 3C according to the document number stored in the storage unit 120.

The printing unit 140 prints the print data converted by the converting unit 130.

While described as including an interface similar to the one in FIG. 2, through which the user sets whether to print plural documents on one page, it is understood that the converting unit 130 can be provided by the print driver according to other aspects of the invention.

Hereinafter, an example of printing four documents on one print page using the above-described printing system according to an embodiment of the present invention will now be described. The user opens document 1 using an application program, and sets the print format in the print format unit 300, the document number in the document number set-up unit 310, and the document sequence in the document sequence set-up unit 320 in the interface provided by the application program as shown in FIG. 2. For instance, the user checks “Print plural documents on one page” for the print format 300, “4” for the document number 310, and “1” for the document sequence 320. Document 1 is stored in the storage unit 120.

Next, the user opens document 2 using the application program, and sets “3” for the document sequence 320 in the interface provided by the application program. Document 2 is stored in the storage unit 120.

The user opens document 3 using the application program, and sets “Regular print” for the document sequence 320 in the interface provided by the application program, so that only document 3 may be printed. In this case, document 3 is not stored in the storage unit 120, but is printed directly onto the paper. While described as printed onto paper, it is understood that other print media such as transparencies for overhead projectors can be used.

The user opens document 4 using the application program, and sets “2” for the document sequence 320 in the interface provided by the application program. Document 4 is stored in the storage unit 120.

Subsequently, the user opens document 5 using the application program, and sets “4” for the document sequence 320 in the interface provided by the application program. Document 5 is stored in the storage unit 120. Since the document number 310, “4”, is equal to the number of documents stored in the storage unit 120, the converting unit 130 miniaturizes each page of documents 1, 2, 4 and 5, and converts them into print data accommodated to one print page according to the document sequence. Then the printing unit 140 prints the print data onto the print papers.

According to an embodiment of the present invention, when the user sets the print format 300, the document number 310, and the document sequence 320 in the interface provided by the print driver, these values are adopted as the default values. That is, an interface that the application program later provides displays these user set values in the interface provided by the print driver as default values, and the user may change these default values.

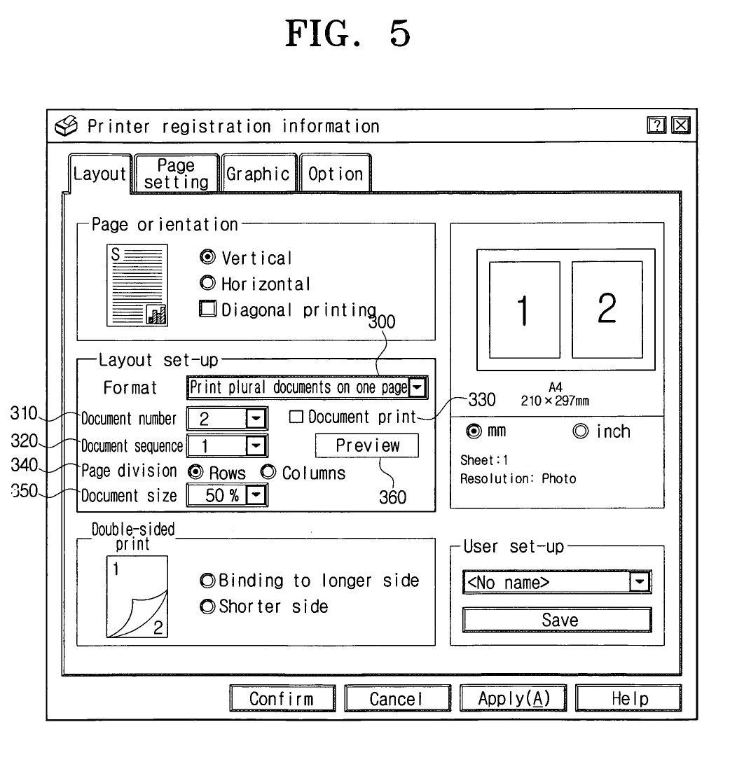

FIG. 5 shows a user interface used for setting print options, according to another embodiment of the present invention. As can be seen in FIG. 5, the user interface includes a page split set-up unit 340, a document size set-up unit 350, and/or a preview set-up unit 360.

The page split set-up unit 340 allows the user to divide the page in several columns and rows. For example, when two documents need to be printed on one page, the converting unit 130 may lay out the documents as shown in FIG. 3D or FIG. 3E.

The document size set-up unit 350 allows the user to set the size of each page of plural documents printed on one page. For example, when two documents need to be printed on one page, 100% is divided by 2 and 50% is displayed as a default value in the document size set-up unit 350. Here, the user may change the default value to 70% if desired. As such, the plural documents are laid out and printed as shown in FIG. 3F and FIG. 3G, respectively.

The preview set-up unit 360 allows the user to set a preview option to preview the plural documents in a print format in which the plural documents are going to be printed.

The preview screen processing unit 110, shown in FIG. 1, generates a preview screen for plural documents selected by the user and displays the preview on a predetermined display means. This is a benefit to the user. When the user sets the preview option through the preview set-up unit 360, the preview screen processing unit 110 generates a preview screen and displays it on the user interface 100.

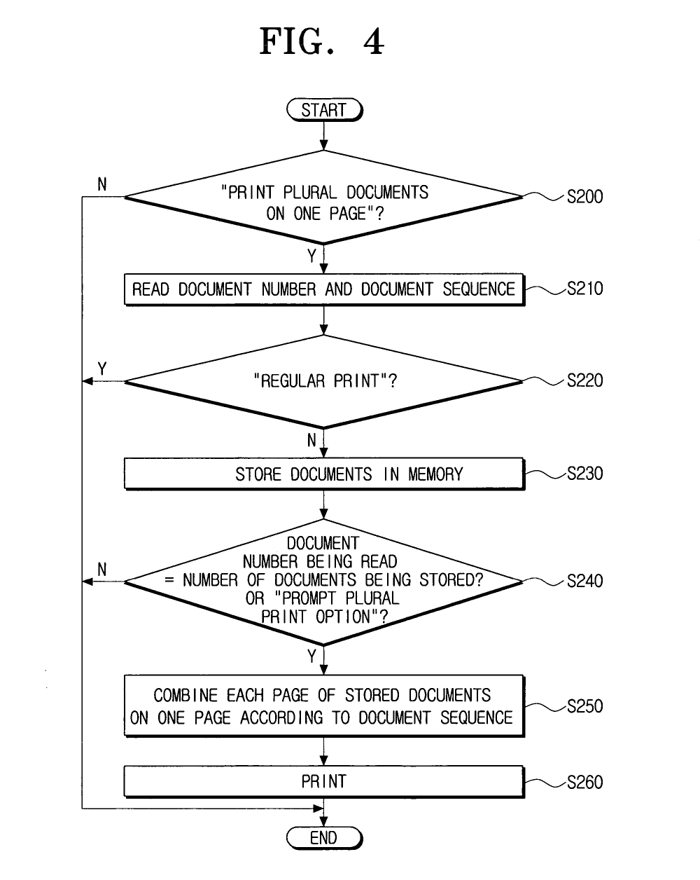

FIG. 4 is a flow chart explaining a printing method according to an embodiment of the present invention.

As described above, the printing system allows the user to set the print format, the document number, the document sequence, and the prompt plural print option through the user interface 100, and the printing system executes the plural document printing on one page based on the user set print options as follows. In the following description, it is assumed that the user sets these options using the user interface shown in FIG. 2.

At first, in operation S200, when a print command is issued, the printing system judges whether the user sets the print format for printing plural documents on one page. For instance, if the user did not check the “Print plural documents on one page” 300 illustrated in FIG. 2 (S200: N), the printing system does not include a target document in the page for plural document printing, but prints the document alone.

If the user checked the “Print plural documents on one page” 300 illustrated in FIG. 2 (S200: Y), the printing system reads the document number 310 and the document sequence 320 (S210). Nevertheless, if the “Regular print” is checked in the document sequence 320 (S220: Y), the printing system, as done in operation S200: N, prints the target document alone.

Meanwhile, if the “Regular print” is not checked in the document sequence 320 (S220: N), the target document is stored in the memory (S230). At this time, the document number 310 and/or the document sequence 320 read in operation S210 may be stored also.

In operation S240, the printing system judges whether the number of documents stored in operation S230 corresponds to the document number 310 read from the user interface 100, or whether the prompt plural print operation 300 is set. This is done to determine whether to combine plural documents to print on one page.

If the number of documents stored in operation S230 does not correspond to the document number 310 read from the user interface 100 and the prompt plural print option 330 is not set (S240: N) either, the target document is only stored in operation S230 and not printed.

On the other hand, if, the number of documents stored in operation S230 corresponds to the document number 310 read from the user interface 100 or the prompt plural print option 330 is set (S240: Y), the printing system converts each page of the documents stored in operation S230 into print data to print corresponding pages from each document on one page according to the document sequence (S250).

Thereafter, the converted print data in operation S250 are printed onto a paper page or series of pages (S260).

The printing system obtains further information on the page split method, the document size and the preview option from the user through the user interface 100 shown in FIG. 5. Based on these user set options, the printing system combines and converts each page of the documents in operation S250.

According to an embodiment of the invention, the preview function provides the benefit to the user in that he can see in advance how the plural documents are going to be printed.

As described above, the printing system and method of the present invention are capable of printing corresponding pages of at least two documents together on one page, and thereby enable the user to easily compare the documents to each other. While not required in all aspects, portions of the method can be implemented using computer software and/or firmware encoded on one or more computer readable media to be implemented on one or more computers.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A printing system to print plural documents on one page, comprising:
a user interface in which a plural print option to print plural documents on the one page is set;
a converting unit to convert the plural documents into print data to be printed on the one page; and
a printing unit to print the print data.

2. The printing system of claim 1 further comprising:
a storage unit to store the plural documents for which the plural print option is set, and
wherein, the converting unit converts the plural documents stored in the storage unit into print data to be printed on the one page.

3. The printing system of claim 1, further comprising:
a preview screen processing unit to generate a preview screen of the print data and display the preview screen on the user interface.

4. A method of printing plural documents on one page, comprising:
obtaining a plural print option for printing plural documents on the one page;
converting the plural documents a user selects into print data to be printed on the one page; and
printing the print data.

5. The printing method of claim 4, further comprising:
storing the plural documents for which the plural print option is set, and
wherein, in the conversion, converting the plural documents stored in the storage unit into print data to be printed on the one page.

6. The printing method of claim 4, wherein, at least one of: a number of the plural documents to be printed on one page, a document sequence, a page split method, a document size, and a preview option is obtained as the plural print option.

7. The printing method of claim 4, wherein the conversion is executed when a number of plural documents set in the plural print option corresponds to a predetermined document number.

8. The printing method of claim 7, wherein, even though the number of plural documents set in the plural print option does not correspond to the predetermined document number, the conversion is executed when a prompt plural print option is set.

9. The printing method of claim 4, wherein the conversion is executed according to a predetermined print sequence, and the print sequence is changeable.

10. The printing method of claim 4, wherein the conversion is executed according to either a horizontal page split method or a vertical page split method.

11. The printing method of claim 4, wherein the conversion is executed according to a predetermined document size.

12. The printing method of claim 4, further comprising:
displaying a preview screen of the print data.

13. The printing method of claim 4, wherein the conversion is realized in a printer driver.

14. The printing method of claim 4, further comprising:
printing a corresponding portion from each of two documents on a half of the printed one page.

15. The printing method of claim 4, further comprising:
printing a corresponding portion from each of four documents on a quadrant of the printed one page.

16. The printing method of claim 4, further comprising:
bypassing the plural documents converted into print data; and
printing a single document.

17. A method of printing content from plural documents on one page, comprising:
receiving a request to print content of a document on the one page with content of another document;
arranging the content from the plural documents on the one page; and
printing the one page.

18. The printing method of claim 17, further comprising:
miniaturizing the content from the plural documents.

19. The printing method of claim 17, further comprising:
arranging corresponding content from the plural documents on the one page.

20. The printing method of claim 17, further comprising:
displaying a preview of the one page;

21. The printing method of claim 17, further comprising:
miniaturizing the content from two documents to one-half page size; and
arranging the corresponding content from the two documents on each half of the one page.

22. The printing method of claim 17, further comprising:
miniaturizing the content from four documents to one-quarter page size; and
arranging the corresponding content from the four documents on each quadrant of the one page.
